(19) United States
(12) Patent Application Publication
(10) Pub. No.: US 2012/0298094 A1
(43) Pub. Date: Nov. 29, 2012

(54) Thermal Insulation Apparatus And Method

(76) Inventor: Chao-Hui Lin, Stafford, TX (US)

(21) Appl. No.: 13/117,075

(22) Filed: May 26, 2011

(51) Int. Cl. F24C 15/34; B23P 19/00

(52) U.S. Cl. 126/1 F; 29/428

(57) ABSTRACT

A thermal insulation apparatus for a burner comprises a bracket, which is attached to the bottom of the burner, a thermal insulating device disposed above the bracket, a thermal seal interposed between the thermal insulating devices for integrating adjacent thermal insulating devices; wherein the thermal seal is adhesive, and a thermal insulating tape wrapping around the exterior surface of the thermal insulating device for enhancement of thermal insulation by letting the thermal insulating device get closer to each other and to the burner. The thermal insulating device is preferably made of the materials with equal to or more than 1000 degrees Fahrenheit of heat resistant temperature and with equal to or less than 4 Watts per meter kelvin of thermal conductivity. A supporter can be disposed between the bracket and the thermal insulating device to provide further supporting.

### FIELD OF THE INVENTION

The present invention relates to the field of a thermal insulation apparatus and the method of installation of the same. More particularly, the present invention relates to an apparatus and a method for insulating a heat-sensitive burner for stabilizing temperature profiles of industrial woks or range.

### BACKGROUND OF THE INVENTION

This section provides background information related to the present disclosure which is not necessarily prior art.

The Chinese wok range, such as Allstrong's or Golden Gate Restaurant Equipment's Chinese wok range series, is a conventional appliance for restaurants, especially Chinese restaurants.

However, there are two major disadvantages of the design of the Chinese wok range. First, overheating of exterior surfaces of the Chinese wok range, especially the surface which chefs are in touch with or close to for all day long, may bring bad influence on chefs' health. According to experimental results, temperature of the exterior side surfaces of the conventional Chinese wok range can reach 800 degrees Fahrenheit. Human body can possibly be hurt by being explored to overheated environment for long time. Second, unnecessary loss of heat decreases the burn efficiency of gasoline of the Chinese wok range. The heat may be lost by being transferred from a burner to exterior surfaces of the Chinese wok range, instead of a pan on the burner. As a result, heat energy is wasted.

### SUMMARY OF THE INVENTION

This section provides a general summary of the disclosure, and is not a comprehensive disclosure of its full scope or its entire feature.

In one embodiment, a thermal insulation apparatus for a burner includes a bracket, which is attached to the bottom of the burner, a thermal insulating device disposed above the bracket, a adhesive thermal seal interposed between the thermal insulating devices for integrating adjacent thermal insulating devices, and a thermal insulating tape wrapping around the exterior surface of the thermal insulating device for enhancement of thermal insulation by letting the thermal insulating device get closer to each other and to the burner.

In some embodiments, the thermal insulation apparatus for a burner further comprises a supporter disposed between the bracket and the thermal insulating device for further supporting the thermal insulating device.

In some embodiments, the supporter further comprises a bottom plate and a flange for preventing movement of the thermal insulating device.

In some embodiments, the supporter is semicircle-shaped.

In some embodiments, the supporter is wedged between the exterior surface of the burner and the bracket, which has a vertical protrusion in the end.

In some embodiments, the total number of the bracket is 6.

In still some embodiments, one end of the bracket is coupled to the interior surface of the burner to minimize the area of the bracket, which contacts a fire under the conventional burner directly resulting in attrition.

In another embodiment, the thermal insulating device is made of a material with equal to or more than 1000 degrees Fahrenheit of heat resistant temperature.

In still another embodiment, the thermal insulating device is made of a material with equal to or less than 4 Watts per meter kelvin of thermal conductivity.

In still another embodiment, the thermal insulating device is cenosphere.

In still another embodiment, the thermal insulating device is clay.

In still another embodiment, the thermal seal is made of a material with equal to or more than 1000 degrees Fahrenheit of heat resistant temperature.

In still another embodiment, the thermal insulation apparatus for a burner further includes a metal plate surrounding the exterior surface of the thermal insulting tape for enhancement of thermal insulation, decrease of the exposure of the thermal insulation apparatus to an ambient condition, and collision prevention.

In still another embodiment, the thermal insulation apparatus for a burner further includes a strap being tied up to the exterior surface of the metal plate.

In still another embodiment, the thermal insulation apparatus for a burner further includes a buckle to lock the strap.

In one preferred embodiment, a method of installing a thermal insulation apparatus to a burner includes the steps of providing and attaching a bracket to the bottom of the burner, disposing a thermal insulating device above the bracket, interposing a thermal seal between the thermal insulating devices for integrating adjacent thermal insulating devices, and wrapping a thermal insulating tape around the exterior surface of the thermal insulating device for enhancement of thermal insulation by letting the thermal insulating device get closer to each other and to the burner.

In some embodiments, the method of installing a thermal insulation apparatus to a burner further comprises the step of disposing a supporter between the bracket and the thermal insulating device.

In some embodiments, the method of installing a thermal insulation apparatus to a burner further includes the step of providing a metal plate to surround the exterior surface of the thermal insulating tape for enhancement of thermal insulation, decrease of the exposure of the thermal insulation apparatus to an ambient condition, and collision prevention.

In other embodiments, the method of installing a thermal insulation apparatus to a burner further includes the step of tying up a strap to the exterior surface of the metal plate.

In still other embodiments, the method of installing a thermal insulation apparatus to a burner further comprises the step of providing a buckle to lock the strap.

### BRIEF DESCRIPTION OF THE DRAWINGS

The drawings described herein are for illustrating purposes only of selected embodiments and not all possible implementation and are not intended to limit the scope of the present disclosure.

FIG. 1 is a perspective view of an embodiment of a thermal insulation apparatus.

FIG. 2 is a perspective view of an embodiment of a thermal insulation apparatus.

FIG. 3a is a perspective view of a burner with brackets.

FIG. 3b is a top view of the burner with brackets in FIG. 3a.

FIG. 3c is a front view of the burner with brackets in FIG. 3a.

FIG. 4a is a side view of a pair of supporters.

FIG. 4b is a top view of the pair of supporters in FIG. 4a.

FIG. 5a is a perspective view of a burner with thermal insulating devices and thermal seals attached.

FIG. 5b is an exploded view of the thermal insulating devices in FIG. 5a.

FIG. 6 is a conventional wok range enclosed with a thermal insulation apparatus.

### DETAILED DESCRIPTION OF THE PREFERRED EMBODIMENT

The following description of the preferred embodiment is merely exemplary in nature and is no way intended to limit the invention, its application, or uses. Example embodiments will now be described more fully with reference to the accompanying drawings.

It is understood that the present invention can be applied to any size, shape, and style of wok, range, oven, stove, burner, and cook appliance. It is also understood that the Chinese wok range application provided here is only exemplary.

A thermal insulation apparatus according to the present invention solves two major problems of the conventional Chinese wok range by directly coupling a thermal insulation apparatus to a burner of the conventional Chinese wok range for stabilizing the thermal profile of the Chinese wok range. First, the thermal insulation apparatus according to the present invention can maintain the temperature of the exterior side surface of the Chinese wok range at around 100 degrees Fahrenheit every time when the burner heats up during each “busy hour”, which may last 2 to 3 hours. Restaurants usually have 2 to 3 “busy hour” per day. The temperature of the exterior side surface of the Chinese wok range would not increase severely due to consecutive burning during the “busy hour.” As a result, the kitchen environment can be improved and the chefs' work efficiency also can be increased correspondingly. The most important is that the chefs' health can be adequately protected, especially the health of men' privates, which are mostly close to the exterior side surface of the Chinese wok range.

Second, the thermal insulation apparatus according to the present invention can help to trap the heat energy generated in each burner heat up cycle. Because the heat energy is insulated in the burner, the burner can increase combustion temperature more easily during each next heat up cycle. In addition, temperature difference between exterior surfaces and interior surfaces of the Chinese wok range causes heat convection. As a result, combustion intensity of the Chinese wok range gets increased and the ventilation of the kitchen gets improved. Workers can feel more comfortable and cooler because heat is carried away from their near-body envelope of air by the wind. The more heat convection occurs, the harder the wind blows. In summary, the Chinese wok range, in which installed the thermal insulation apparatus becomes more environmentally friendly.

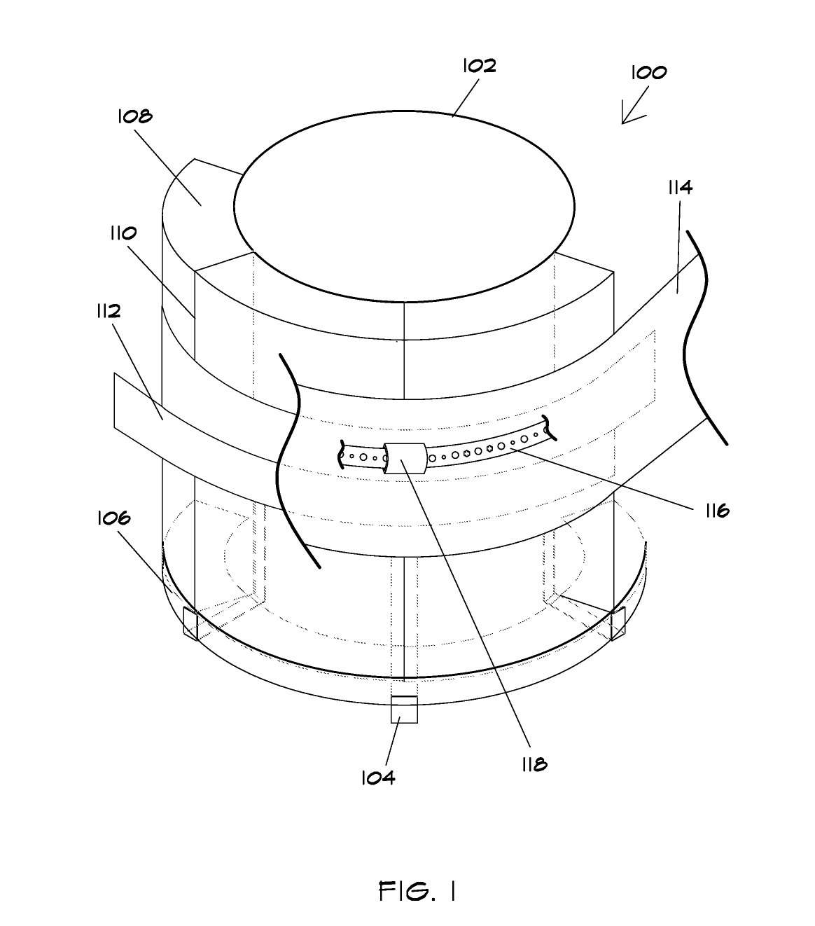

FIG. 1 illustrates a perspective view of an embodiment of a thermal insulation apparatus 100. The thermal insulation apparatus 100 can include a bracket 104, a supporter 106, a thermal insulating device 108, a thermal seal 110, and a thermal insulating tape 112. Multiple brackets 104 can be partially attached at the bottom of the burner 102 of the Chinese wok range and partially extend out of the edge of the burner 102 for supporting the thermal insulating device 108. The bracket 104 can be in L shape or any other shape. The supporter 106 can be placed on the extended parts of the brackets 104 for further supporting the thermal insulating devices 108 posited on the top of it. The supporter can be curved shaped. The thermal seals 110 are adhesive materials for integrating adjacent thermal insulating devices 108. The thermal insulating tape 112 is for enhancing thermal insulation by wrapping around the thermal insulating devices 108 to let the thermal insulating devices 108 get closer to the burner 102 and to diminish any interval between the thermal insulating devices 108. The thermal insulating tape 112 can be made of insulting materials, preferably asbestos, whose heat resistant temperature is 3218˜3632 degrees Fahrenheit. However, any banding materials with more than 1000 degrees Fahrenheit of heat resistant temperature can be used as the thermal insulating tape 112.

In some embodiments, a metal plate 114, shown in FIG. 1, can be applied to the thermal insulation apparatus 100 for enhancement of thermal insulation, decrease of the exposure of the thermal insulation apparatus 100 to ambient condition, and collision prevention. The metal plate 114 can surround the exterior surface of the thermal insulting tape 112, and be preferably made of zinc and with 30˜32 gauges, and 4 or 6 inches in width.

In other embodiments, a strap 116 and a buckle 118, shown in FIG. 1, can be applied to the metal plate 114 for prevention of the metal plate 114 loosening by being tied up to the exterior surface of the metal plate 114 or the thermal insulating tape 112 directly. The buckle 118 can help to lock the strap 116. Alternatively, the strap 116 can be fixed on the metal plate 114 or the thermal insulating tape 112 alone without the buckle 118.

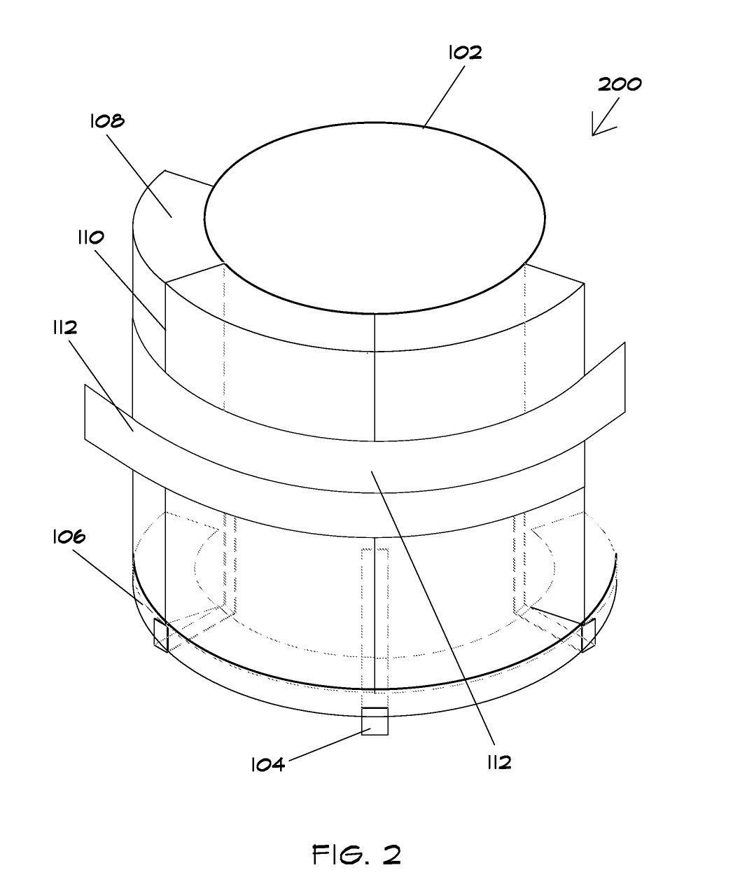

FIG. 2 illustrates a perspective view of another embodiment of a thermal insulation apparatus 200. The thermal insulation apparatus 200 comprises all elements in FIG. 1, except for the metal plate 114, the strap 116, and the buckle 118.

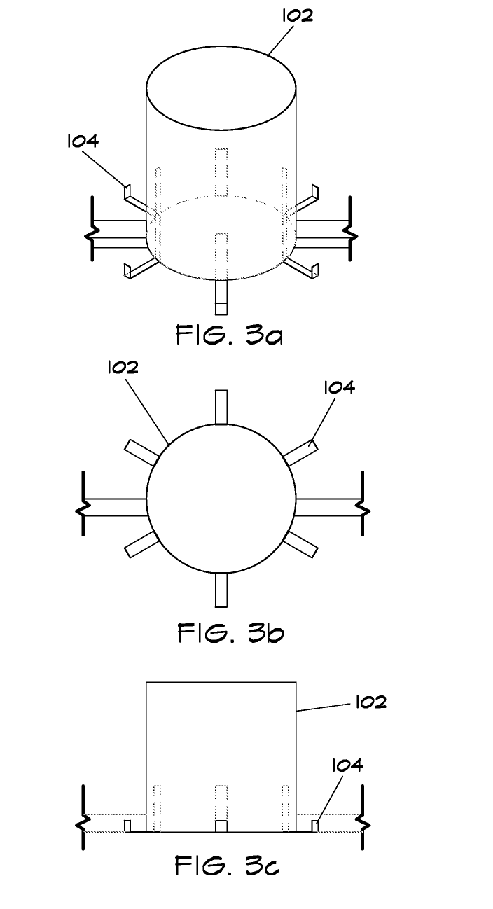

FIGS. 3a, 3b, and 3c illustrate a perspective view, a top view, and a front view of the burner 102 coupled with the brackets 104. Multiple brackets 104, preferably 6 brackets 104, are attached to the bottom of the burner 102 of the Chinese wok range. They can be posited equidistantly or non-equidistantly around the burner 102. One end of the bracket 104 can be welded to the interior surface of the burner 102 to minimize the area of the bracket 104, which contacts fire directly resulting in attrition. The other end of the bracket 104 has a vertical protrusion for wedging the supporter 106 between the interval of the vertical protrusion of the bracket 104 and the exterior surface of the burner 102 without any welding procedure.

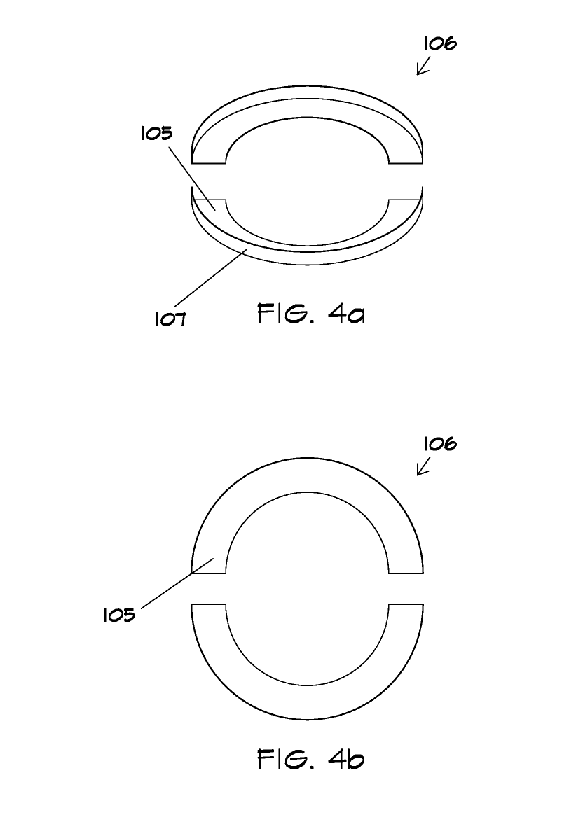

FIGS. 4a and 4b illustrate a side view and a top view of a pair of supporters 106. The supporter 106 can include a bottom plate 105 and a flange 107. The flange 107 can prevent movement of the thermal insulating device 108 and enforce the structure of the supporter 106. The supporter 106 are preferably semicircle-shaped for easy installation and transportation. Basically, installers do not need to scrawl to the bottom of the burner 102 to install the thermal insulation apparatus according to the prevent invention.

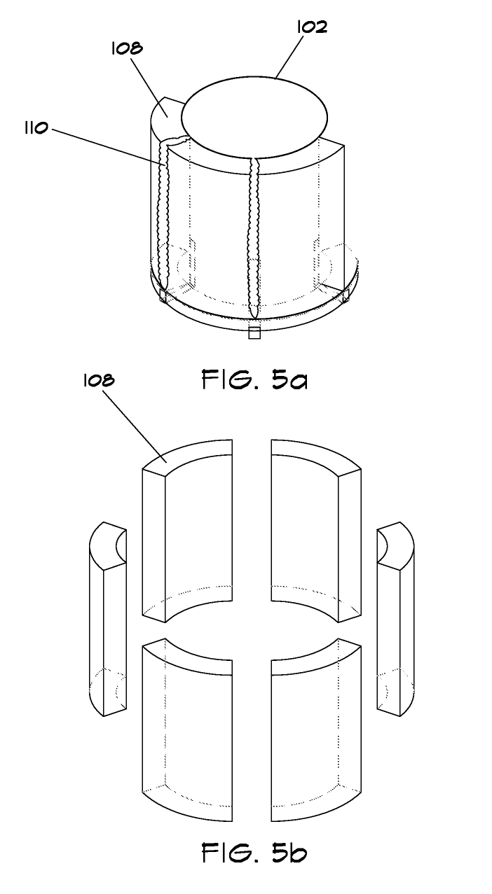

FIG. 5a illustrates a perspective view of the burner 102 with thermal insulating devices 108 and thermal seals 110 attached and FIG. 5b illustrates an exploded view of the thermal insulating devices 108. The thermal insulating device 108 and the thermal seal 110 are both critical components for preventing heat loss from the burner 102 and maintaining stable temperature of the exterior surface of the conventional wok range. Therefore, the materials of the thermal insulating device 108 and the thermal seal 110 are made of materials, which have high heat resistant temperature and low thermal conductivity. As a result, combustion efficiency of the burner 102 can be largely improved to save heat energy. Also, because the temperature of the exterior surface of the conventional wok range decreases, the working environment becomes more friendly to chefs or workers in the kitchen.

The materials for the thermal insulating devices 108 can be the materials with equal to or more than 1000 degrees Fahrenheit of heat resistant temperature and with equal to or less than 4 Watts per meter kelvin (W/m·k) of thermal conductivity, such as cenosphere, whose thermal conductivity is 0.03˜0.08 W/m·k and whose intensity is 0.8 g/cm², or clay. The materials for the thermal seals 110 can be the materials with equal to or more than 1000 degrees Fahrenheit of heat resistant temperature, such as adhesive glues. In addition, both the thermal insulating devices 108 and the thermal seals 110 can be made by flexible materials to fit any size of burner, and therefore the manufacture, transportation, storage, and installation of the thermal insulation apparatus according to the present invention would not cause any breakage and can save a lot of costs.

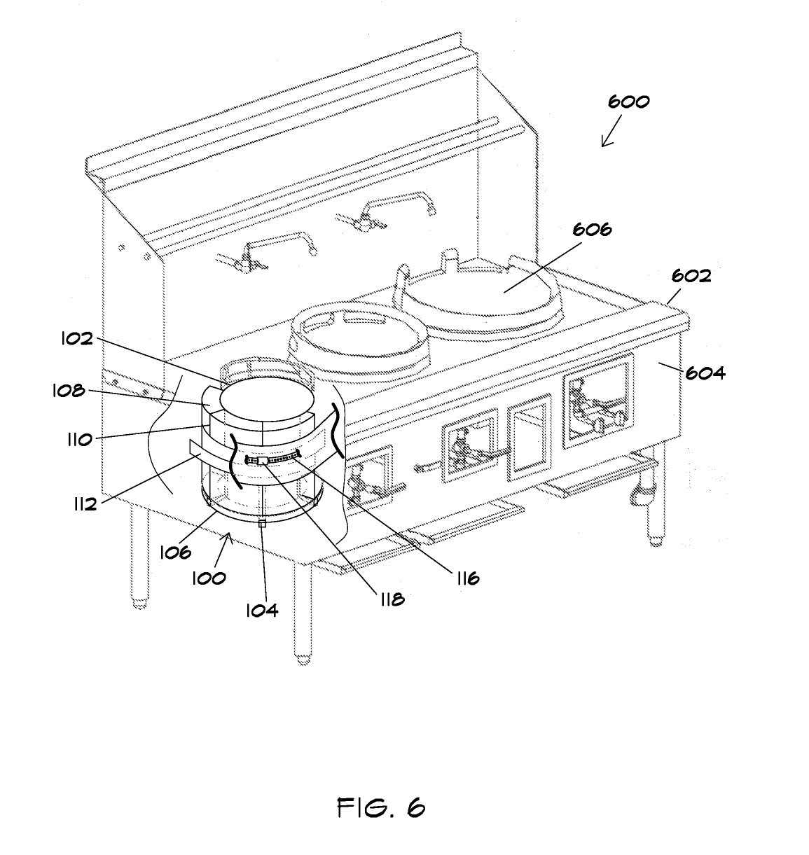

FIG. 6 illustrates a conventional wok range enclosed with a thermal insulation apparatus 100. According to experimental results, taking a conventional burner with 13 inches in diameter as an example, the conventional burner with the thermal insulation apparatus can increase 15˜20% of the combustion efficiency by showing following facts.

1) Increase of burner temperature: the speed to boil 6 Pounds of water in the conventional burner with the thermal insulation apparatus according to the present invention is 31˜34 seconds faster than it of the conventional burner alone.

2) Increase of heating power: the speed to increase 50 degrees Fahrenheit of the temperature of 4 Pounds of oil in the conventional burner with the thermal insulation apparatus according to the present invention is 4˜6 seconds faster than it of the conventional burner alone.

3) Increase stabilization of temperature: a) 10 minutes after achieving 1000 degrees Fahrenheit, there are 126˜152 degrees Fahrenheit difference between the temperature decrease of the conventional burner with the thermal insulation apparatus according to the present invention and it of the conventional burner alone. b) the speed to achieve 1000 degrees Fahrenheit of the conventional burner with the thermal insulation apparatus according to the present invention after firstly achieving 1000 degrees Fahrenheit is 27˜35 seconds faster than it of the conventional burner alone.

A method of installing a thermal insulation apparatus to a burner 102 can include the steps of providing and attaching a bracket 104 to the bottom of the burner 102, disposing a thermal insulating device 108 above the bracket 104, interposing a thermal seal 110 between the thermal insulating devices 108 for integrating adjacent thermal insulating devices 108, and wrapping a thermal insulating tape 112 around the exterior surface of the thermal insulating device 108 for enhancement of thermal insulation by letting the thermal insulating device 108 get closer to each other and to the burner 102.

In some embodiments, the method of installing a thermal insulation apparatus to a burner 102 can further include the step of disposing a supporter between the bracket 104 and the thermal insulating device 108.

In some embodiment, the method of installing a thermal insulation apparatus to a burner 102 can further include the step of providing a metal plate 114 to surround the exterior surface of the thermal insulating tape 112 for enhancement of thermal insulation, decrease of the exposure of the thermal insulation apparatus to an ambient condition, and collision prevention.

In another embodiment, the method of installing a thermal insulation apparatus to a burner 102 can further include the step of tying up a strap 116 to the exterior surface of the metal plate 114.

In still another embodiment, the method of installing a thermal insulation apparatus to a burner 102 can further include the step of providing a buckle to lock the strap.

The present invention has been described in the terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A thermal insulation apparatus for a burner comprising:
a bracket; wherein the bracket is attached to the bottom of the burner;
a thermal insulating device disposed above the bracket;
a thermal seal interposed between the thermal insulating devices for integrating adjacent thermal insulating devices; wherein the thermal seal is adhesive; and
a thermal insulating tape wrapping around the exterior surface of the thermal insulating device for enhancement of thermal insulation by letting the thermal insulating device get closer to each other and to the burner.

2. The thermal insulation apparatus for a burner according to claim 1 further comprising a supporter disposed between the bracket and the thermal insulating device for further supporting the thermal insulating device.

3. The thermal insulation apparatus for a burner according to claim 2 wherein the supporter further comprising a bottom plate and a flange for preventing movement of the thermal insulating device.

4. The thermal insulation apparatus for a burner according to claim 2 wherein the supporter is semicircle-shaped.

5. The thermal insulation apparatus for a burner according to claim 2 wherein the supporter is wedged between the exterior surface of the burner and the bracket, which has a vertical protrusion in the end.

6. The thermal insulation apparatus for a burner according to claim 1 wherein the total number of the bracket is 6.

7. The thermal insulation apparatus for a burner according to claim 1 wherein one end of the bracket is coupled to the interior surface of the burner to minimize the area of the bracket, which contacts a fire under the burner directly resulting in an attrition.

8. The thermal insulation apparatus for a burner according to claim 1 wherein the thermal insulating device is made of a material with equal to or more than 1000 degrees Fahrenheit of heat resistant temperature.

9. The thermal insulation apparatus for a burner according to claim 1 wherein the thermal insulating device is made of a material with equal to or less than 4 Watts per meter kelvin of thermal conductivity.

10. The thermal insulation apparatus for a burner according to claim 1 wherein the thermal insulating device is cenosphere.

11. The thermal insulation apparatus for a burner according to claim 1 wherein the thermal insulating device is clay.

12. The thermal insulation apparatus for a burner according to claim 1 wherein the thermal seal is made of a material with equal to or more than 1000 degrees Fahrenheit of heat resistant temperature.

13. The thermal insulation apparatus for a burner according to claim 1 further comprising a metal plate surrounding the exterior surface of the thermal insulting tape for enhancement of thermal insulation, decrease of the exposure of the thermal insulation apparatus to an ambient condition, and collision prevention.

14. The thermal insulation apparatus for a burner according to claim 13 further comprising a strap being tied up to the exterior surface of the metal plate.

15. The thermal insulation apparatus for a burner according to claim 14 further comprising a buckle to lock the strap.

16. A method of installing a thermal insulation apparatus to a burner comprising the steps of:
providing and attaching a bracket to the bottom of the burner;
disposing a thermal insulating device above the bracket;
interposing a thermal seal between the thermal insulating devices for integrating adjacent thermal insulating devices; and
wrapping a thermal insulating tape around the exterior surface of the thermal insulating device for enhancement of thermal insulation by letting the thermal insulating device get closer to each other and to the burner.

17. The method of installing a thermal insulation apparatus to a burner according to claim 16 further comprising the step of disposing a supporter between the bracket and the thermal insulating device.

18. The method of installing a thermal insulation apparatus to a burner according to claim 16 further comprising the steps of providing a metal plate to surround the exterior surface of the thermal insulating tape for enhancement of thermal insulation, decrease of the exposure of the thermal insulation apparatus to an ambient condition, and collision prevention.

19. The method of installing a thermal insulation apparatus to a burner according to claim 18 further comprising the steps of tying up a strap to the exterior surface of the metal plate.

20. The method of installing a thermal insulation apparatus to a burner according to claim 19 further comprising the steps of providing a buckle to lock the strap.
